(19) United States
(12) Patent Application Publication
(10) Pub. No.: US 2007/0231238 A1
(43) Pub. Date: Oct. 4, 2007

(54) METHOD AND PLANT FOR DEPLETING SODIUM THIOCYANATE IN WASHING LIQUORS AND FOR OBTAINING PURE SODIUM THIOCYANATE

(75) Inventors: Wilhelm Hinsen, Ratingen (DE); Hermann Plate, Moers-Vennikel (DE); Gunter Hofmann, Duisburg (DE); Christian Melches, Bochum (DE)

Correspondence Address: VAN DYKE, GARDNER, LINN AND BURKHART, LLP, SUITE 207, 2851 CHARLEVOIX DRIVE, S.E., GRAND RAPIDS, MI, 49546, US

(73) Assignee: GEA MESSO GMBH, Duisburg (DE)

(21) Appl. No.: 11/694,285

(22) Filed: Mar. 30, 2007

(30) Foreign Application Priority Data
Mar. 30, 2006 (DE) 10 2006 014 752.9

(51) Int. Cl. C01B 21/093

(52) U.S. Cl. 423/366

(57) ABSTRACT

A method and apparatus are provided for depleting sodium thiocyanate (NaSCN) from washing solutions to obtain pure sodium thiocyanate. By adding an anti-solvent such as ethanol, which acts as anti-solvent for the main part of the accompanying salts in the solution, the major part of these accompanying salts can be separated by precipitation in a crystallization and removed, for example, by filtration, whereas the NaSCN remains in the solution. After separating the anti-solvent from the remaining aqueous solution in a rectification, a very pure crystallized NaSCN is produced in a NaSCN crystallization. After washing in a counterstream washing apparatus, the obtained crystallized NaSCN product has a purity of at least 99%.

### FIELD OF THE INVENTION

The invention relates generally to a method for depleting sodium thiocyanate (NaSCN), as well as an apparatus for carrying out this method, and a crystallized NaSCN obtained by this method.

### BACKGROUND OF THE INVENTION

When coal is hydrogenated to produce fuel, the resulting product usually contains a certain amount of sulphur that has to be removed. This can be done with a washing process in which a washing liquor is circulated. For example, the so-called Sulfolin process of Linde and the Stretford process provide suitable means for this. However, salts accumulate in the alkaline washing liquor. These are mainly sodium sulphate and sodium thiocyanate from the process reactions. Whereas a method for depleting sodium sulphate in the circulating solution has long been known and is applied relatively free of problems, greater difficulties for removing the NaSCN accumulating considerably more slowly are encountered. To avoid further enrichment and to comply with a maximum specified concentration, the possibility of discarding a part of the circulating solution is employed to a considerable extent. However, this is extremely undesirable for reasons of environmental protection.

The U.S. Pat. No. 3,965,243 discloses a method for obtaining NaSCN from the circulating washing liquor of a Stetford process for removing hydrogen sulphide. For this purpose a part stream of contaminated washing liquor is fed into an extraction stage in which an aliphatic solvent containing 3 to 8 carbon atoms is added to the washing liquor as extraction agent. Preferentially n-butanol (C₄H₉OH) is utilised as solvent that has only limited miscibility (about 20%) with water. The extraction of the NaSCN is performed, for example, in a continuous counterstream extraction with four theoretical stages, whereby preferentially 1.5 parts by volume of n-butanol and 1 part by volume of washing liquor are used. In the extraction stage the solvent removes a considerable fraction of the NaSCN and other contaminating substances out of the washing liquor, which is then subjected to a steam stripping process to remove the residual solvent.

The extract drawn out of the counterstream extraction contains mainly the solvent and a fraction of the water, as well as in particular the main fraction of the NaSCN. To separate the solvent from the aqueous phase, the extract is treated in a distillation apparatus where the n-butanol is driven out as low boiling azeotropic mixture with 42.5% of water. The condensate formed therefrom is decanted and the resulting butanol-rich fraction (80% n-butanol) is returned to the counterstream extraction as solvent, whereas the water-rich fraction (approx. 6% n-butanol) is returned to the distillation. A practically solvent-free aqueous solution of NaSCN can be drawn from the bottom of the distillation apparatus. From this a crude salt containing about 88% NaSCN is then obtained by evaporation concentration, filtration, decolorisation with active charcoal and evaporation to dryness. Pure white NaSCN is produced as marketable salt product by dissolving the crude salt in pure n-butanol, filtering the solution and then re-crystallizing. Utilisation of alternative solvents such as 2-propanol that are well miscible with water is considered to be technically feasible but not economically justified.

The EP 0074278 A1 discloses a method for recovering anthraquinone disulfonate (ADA) and vanadate from the discarded fraction of a circulating liquor of a Stretford process for gas scrubbing. Thereby the solution is brought into contact with active charcoal for separating the anthraquinone disulfonate. The vanadate is separated by contact with an anion exchanger resin. The anthraquinone disulfonate and the vanadate are thereafter washed out of the active charcoal or out of the anion exchanger resin, respectively, with an alkaline aqueous solution that is preferably heated to 25-100° C., and returned into the circulation.

The task of the present invention is to specify a method for depleting NaSCN out of circulating liquors, containing further accompanying salts, of a washing process for removing sulphur, that gives highest possible yield of a crystallized NaSCN as marketable pure product with least possible plant and operating expenditure; thereby the important chemicals for the washing process to remove sulphur, in particular the substances anthraquinone disulfonate (ADA) and sodium vanadate that act as catalysts, are to be recovered to the greatest possible extent. Furthermore, a plant for carrying out this method is to be specified.

### SUMMARY OF THE INVENTION

The present invention provides a method for depleting NaSCN out of circulating liquors, containing further accompanying salts, of a washing process for removing sulphur, that gives highest possible yield of a crystallized NaSCN as marketable pure product with least possible plant and operating expenditure; thereby the important chemicals for the washing process to remove sulphur, such as the substances anthraquinone disulfonate (ADA) and sodium vanadate that act as catalysts, are to be recovered to the greatest possible extent. Furthermore, an apparatus for carrying out this method is to be specified.

A Sulfolin washing liquor after sulphate recovery typically has the following composition, where the maximum concentrations should not be exceeded:

| Component | Unit | min | max |
|---|---|---|---|
| Na₂CO₃ + NaHCO₃ | g/l | 18 | 43 |
| Na₂SO₄ | g/l | 40 | 70 |
| NaSCN | g/l | 80 | 200 |
| NaVO₃ | g/l V | 1.0 | 1.8 |
| ADA (sodium salt of | g/l | 0.2 | 0.5 |
| anthraquinone sulphonic acid) | | | |
| pH value | | 7.7 | 8.8 |

Sodium carbonate is the utilised absorption agent for desulphurisation and is consumed in the washing process. Instead of Na₂CO₃ usually NaOH is fed to the washing solution; the NaOH reacts with CO₂ resulting in Na₂CO₃ and partly NaHCO₃. NaVO₃ and ADA are catalysts, Na₂SO₄ and NaSCN are reaction products that can accumulate in the washing liquor. The Na₂SO₄ is usually removed from the liquor by cooling crystallization of Glauber's salt, so that its concentration in the liquor is limited by this means to the maximum value or less.

Surprisingly it has now been found that by adding certain alcohols to the washing liquor, e.g. to a Sulfolin solution or to the mother liquor of a Glauber's salt crystallization of the washing liquor, a very strong depletion of all salts except for the NaSCN can be achieved by drowning-out crystallization. These certain alcohols are those with at most 2 carbon atoms and have an anti-solvent effect on the major fraction of the salts that accompany the NaSCN in the washing liquor. Unlike the aliphatic alcohols (C3-C8) utilised in the process known from U.S. Pat. No. 3,965,243 these certain alcohols are completely miscible with the aqueous solution; the liquid phase is completely homogeneous. The miscibility to only some extent is essential to the known process in order to separate the NaSCN dissolved in the separate liquid organic phase, having at least 3 carbon atoms, from an aqueous phase by decanting the organic phase. In contrast to the known process all salts of the washing liquor, except for the NaSCN that has good solubility in the anti-solvent, have so small saturation concentrations in the anti-solvent/water mixture according to the invention, that a NaSCN solution only slightly contaminated with the accompanying salts is obtained. Only the ADA is an exception, in that a certain fraction thereof is not precipitated in the drowning-out crystallization.

It was furthermore found that through a preliminary concentration by evaporation crystallization with only subsequent addition of the anti-solvent to the obtained suspension, the ratio of the NaSCN to the other inorganic salts can be further improved to a considerable extent without resulting co-crystallization of NaSCN.

The suspension obtained in this manner is partitioned by known separating steps into crystallized mass and solution, whereby the crystallized mass can be returned to the washing process for removing sulphur. The NaSCN solution contains such a small concentration of the accompanying salts that in a subsequent NaSCN crystallization the NaSCN crystallizes selectively and thus can be obtained directly in a specifically pure form without requiring a re-crystallization. Before the NaSCN crystallization the anti-solvent can first of all be removed again from the solution and returned to the drowning-out crystallization. For this purpose the recovery of an anti-solvent/water mixture is fully sufficient.

Suitable anti-solvents include methanol and ethanol.

These and other objects, advantages, purposes and features of the present invention will become apparent upon review of the following specification in conjunction with the drawings.

### BRIEF DESCRIPTION OF THE DRAWINGS

FIG. 1 is a chart of the solubility of Na₂SO₄ in various solvents;

FIG. 2 is a chart of the solubility of NaSCN in various solvents;

FIG. 3 is a chart of the percentage of purity of NaSCN, depending on the concentration of ethanol;

FIG. 4 is a process schematic of a method according to the present invention;

FIG. 5 is a schematic of an apparatus according to the present invention;

FIG. 6 is a mass balance of an embodiment of the present invention; and

FIG. 7 is a mass balance of a further embodiment of the present invention.

### DESCRIPTION OF THE PREFERRED EMBODIMENTS

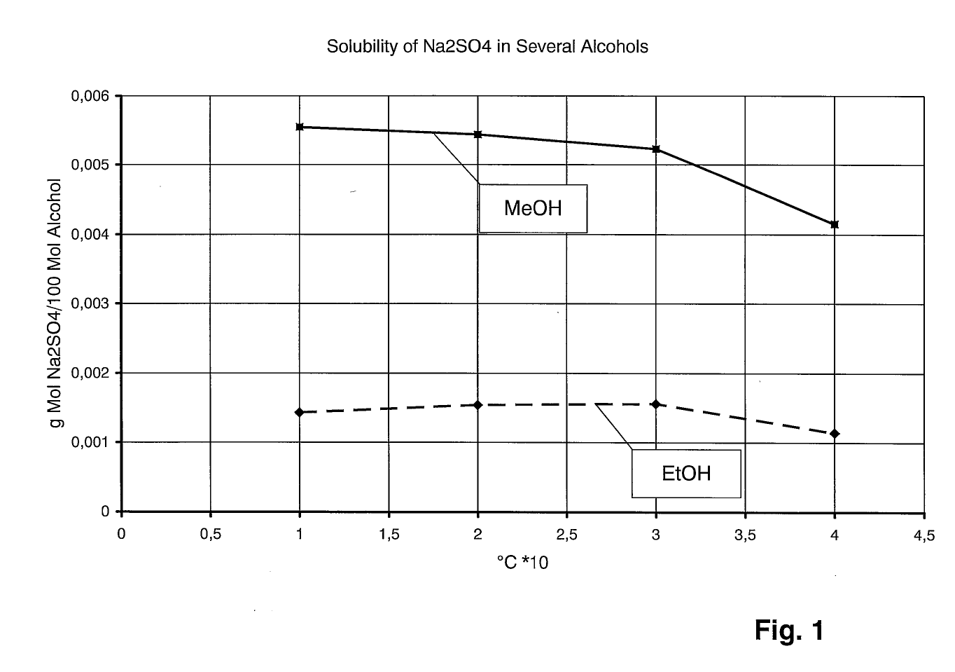

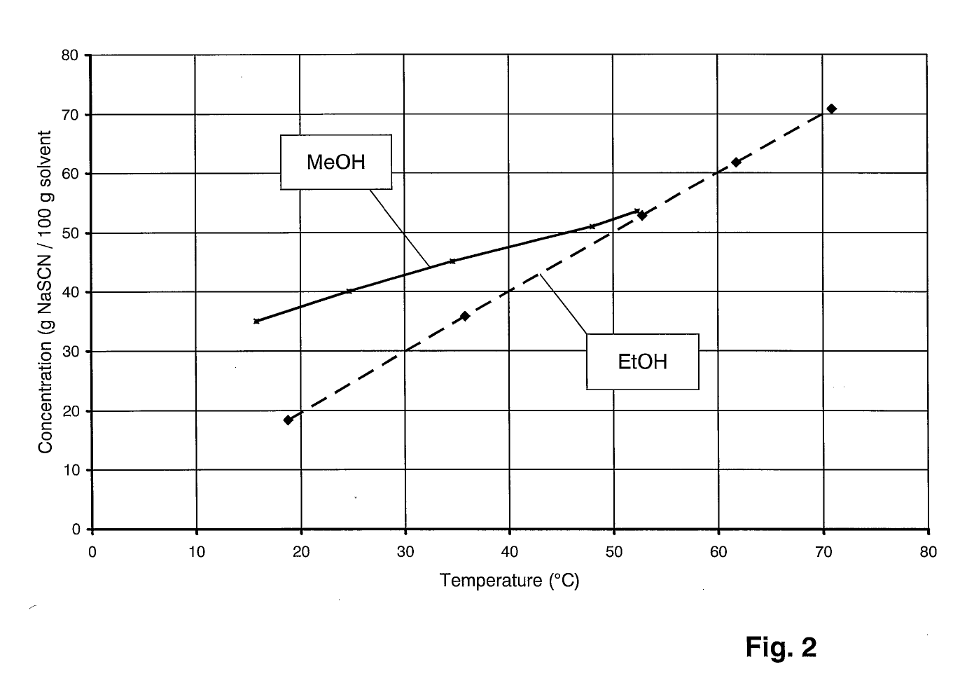

Referring now to the drawings and the embodiments illustrated therein, from FIG. 1 it is evident that Na₂SO₄ has only a very small solubility in the specified alcohols. The same is true for Na₂CO₃ and NaVO₃ (not depicted). In contrast thereto, as shown in FIG. 2, the solubility of NaSCN in these alcohols is much greater. This is especially true for ethanol (2 carbon atoms) that clearly shows the highest solubility values at a temperature above about 55° C. Methanol (1 carbon atom) shows the highest values at temperatures below about 50° C. The combination of the two diagrams characterises ethanol (EtOH) as a well suited anti-solvent within the scope of the present invention, because it is able to dissolve very little Na₂SO₄ but a particularly large amount of NaSCN. In fact, the ADA also dissolves in ethanol, but it does not attain saturation in the mother liquor of the NaSCN crystallization when a small amount of the solution is purged to the crystallization.

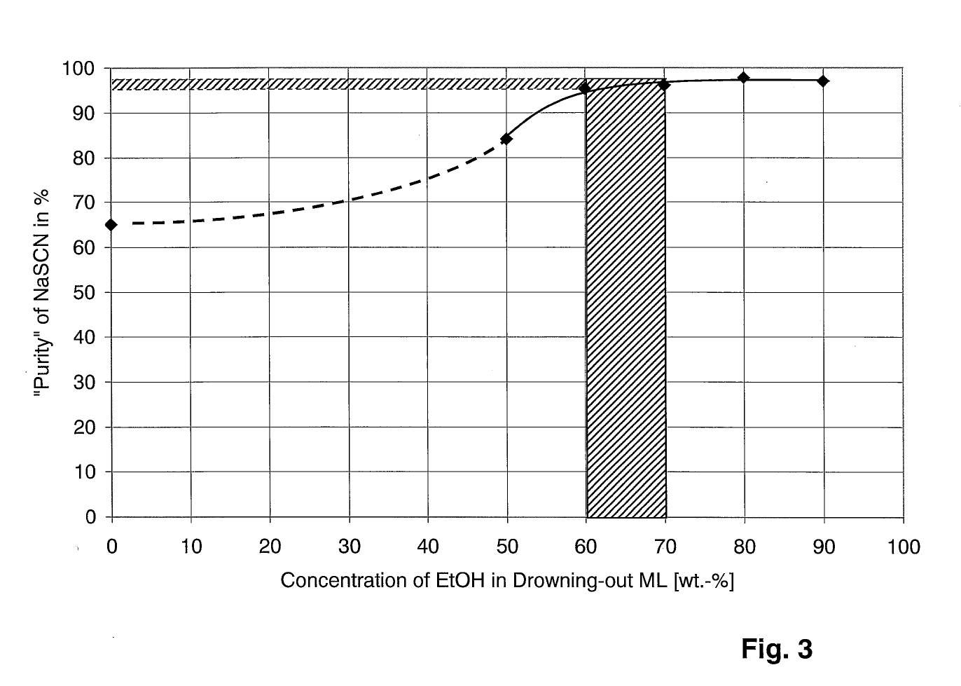

FIG. 3 shows that with a mass percentage concentration of ethanol of 60-70% in the mother liquor, the NaSCN fraction in the dissolved substances already asymptotically approaches the limit value of 95-97% NaSCN. This makes it possible to utilise an EtOH/water mixture as anti-solvent that lies significantly below the composition of the azeotropic mixture (approx. 95% EtOH). Compared therewith the azeotropic mixture of methanol and water contains about 60% of methanol. These properties of EtOH simplify the recovery of the EtOH in this procedure considerably, because an EtOH/water mixture containing, for example, 60-70% of EtOH can already be returned without any problems, so that it is not necessary to break an azeotropic mixture in the recovery procedure.

FIG. 3 shows that with a mass percentage concentration of ethanol of 60-70% in the mother liquor, the NaSCN fraction in the dissolved substances already asymptotically approaches the limit value of 95-97% NaSCN. This makes it advantageously possible to utilise an EtOH/water mixture as anti-solvent that lies significantly below the composition of the azeotropic mixture (approx. 95% EtOH). Compared therewith the azeotropic mixture of methanol and water contains about 60% of methanol. These properties of EtOH simplify the recovery of the EtOH in this procedure considerably, because an EtOH/water mixture containing, for example, 60-70% of EtOH can already be returned without any problems, so that it is not necessary to break an azeotropic mixture in the recovery procedure.

On the basis of this surprising interplay of the different solubilities it is possible to construct a process according to the present invention that is able to deplete NaSCN continuously in the washing process for removing sulphur, and at the same time to obtain NaSCN as industrial product with a purity that had not been achieved previously.

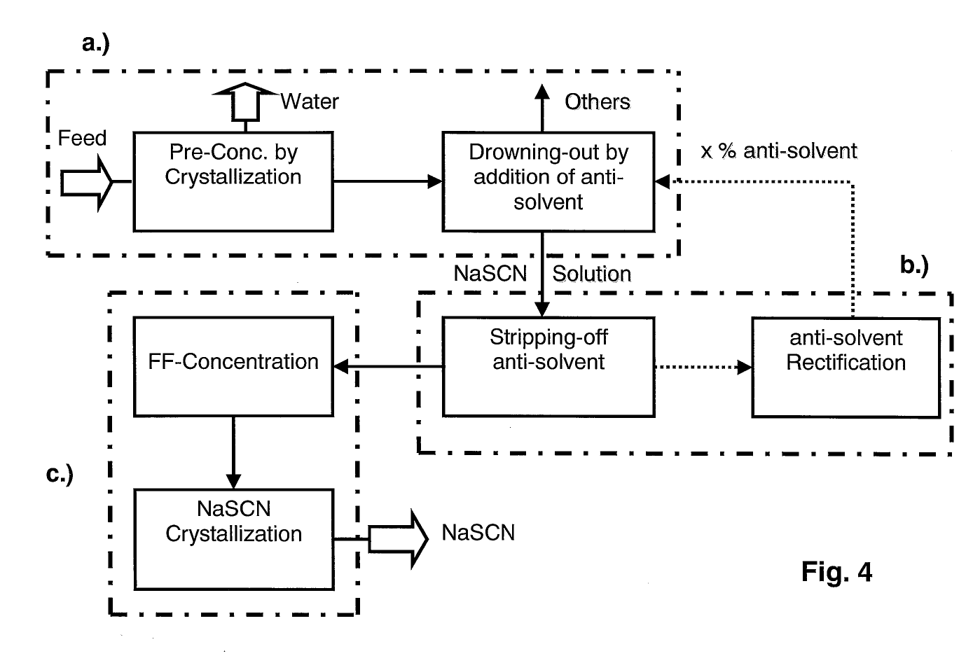

The basic action sequence of the process according to the invention is shown in FIG. 4 in the form of a schematic block diagram, commencing with the take over of a part or partial stream of washing liquor, for example from a (not depicted) Sulfolin process. The dot-dash line frames contain the respective three main functional blocks, namely:

a. the separation of the product solution

b. the recovery of the anti-solvent

c. the product crystallization

The separation of the product solution, that is the NaSCN solution, from the main fraction of the accompanying salts takes place by addition of anti-solvent in a crystallization that is preceded by a preliminary crystallization in which most of the water is removed from the solution. The anti-solvent recovery comprises stripping and rectification of the anti-solvent from the NaSCN solution (both achievable in a single process unit), whereby in the depicted case the anti-solvent is not separated in completely pure state, but instead as anti-solvent/water mixture containing x % of anti-solvent. The third main functional block is the product crystallization including a stage for increasing the concentration of the solution.

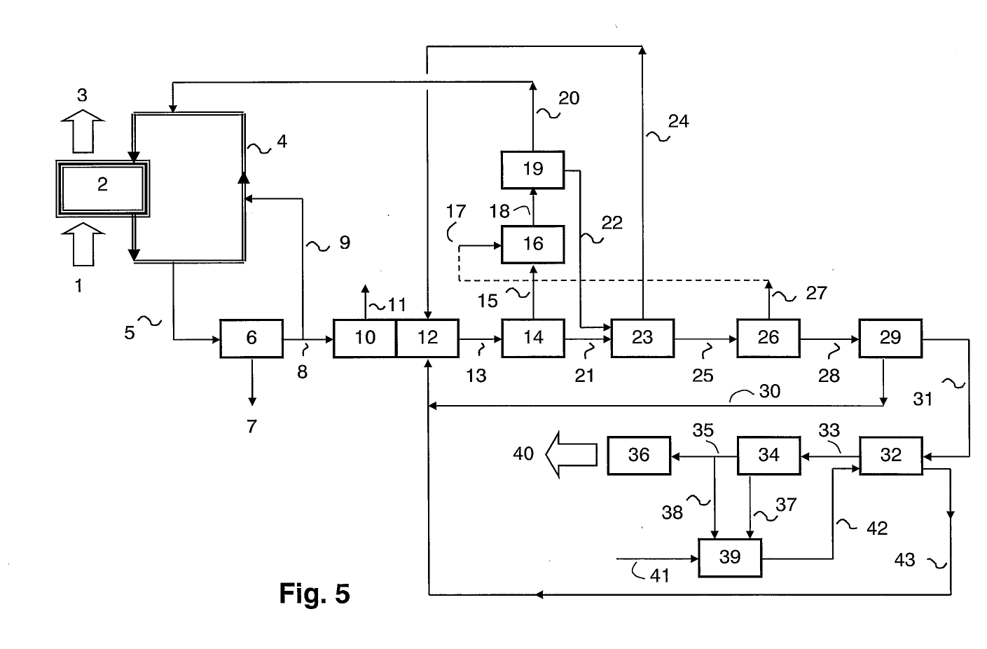

The basic design of a plant for carrying out the process according to the invention is shown in FIG. 5. This depicts a continuously operating cleaning plant 2 (e.g. a Sulfolin plant) for removing sulphur from a material 1 containing sulphur (e.g. petrol) that leaves the cleaning plant 2 again as desulphurised material 3. The washing circuit of the cleaning plant 2 is designated with 4. Via a purge line 5 a part stream of the alkaline washing liquor is continuously taken from the washing circuit 4 and fed to a Glauber's salt crystallization 6 in which the Na₂SO₄ crystallizes and is taken out as Glauber's salt stream 7. A part of the mother liquor of the Glauber's salt crystallization 6 goes via a line 8 into a preliminary crystallization 10, whereas the other part of the Glauber's salt depleted mother liquor goes via a mother liquor return line 9 back into the washing circuit 4.

In the preliminary crystallization 10 that is operated at a temperature in the range of 60 to 130° C., optionally in the range of 80 to 100° C., most of the water fraction of the mother liquor is evaporated and removed through a water vapour exhaust line 11. Downstream of the preliminary crystallization 10 follows directly a crystallization 12, in which an anti-solvent/water mixture is added to the suspension obtained from the preliminary crystallization 10 coming through a line 24. With EtOH the anti-solvent concentration in the mother liquor is appropriately held in the range from 40 to 90 mass %, optionally from 60 to 70 mass %, for example, at 65 mass %. The crystallization 12 may be implemented as cooling crystallization and may be carried out with an operating temperature in the range of 10 to 60° C., optionally in the range of 25 to 35° C. The anti-solvent precipitates the major fraction of the accompanying salts.

The resulting suspension comprising NaSCN solution and a crystallized mass of the accompanying salts is fed through a suspension output line 13 into a separating device that is designed, for example, as a filter 14. The filtrate of the filter 14 (NaSCN solution) is taken through a filtrate output line 21 to a first rectification 23, that may be equipped with an indirect sump heater, for stripping the main fraction of the anti-solvent contained in the solution. The first rectification 23 can be operated such that an anti-solvent/water mixture can be drawn out of it, with a concentration of anti-solvent higher than given in the drowning-out crystallization 12. This mixture can be returned to the crystallization 12 through an anti-solvent/water mixture line 24.

The NaSCN solution is almost completely stripped from the anti-solvent (for example, ethanol) when it leaves the rectification 23 and can be fed through a line 25 into a facility for increasing the concentration, optionally up to close to the saturation point. This may be accomplished with a falling film evaporator 26. With a considerable fraction of water, the very small fraction of remaining anti-solvent in the concentrating device is driven out and drawn off via a vapour line 27. It is possible as option to condense these vapours and feed the condensate completely or partly (depicted as broken line) into a condensate feed line 17 that leads to a dissolving unit 16. The filter cake of the filter 14 is also brought via a filter cake feed 15 into this dissolving unit 16 and dissolves completely in the condensate. Of course, this dissolution could also be performed with other provided water. The resulting solution of accompanying salts, that also contains the ADA and NaVO₃ (the catalysts of the Sulfolin process) is taken, for recovering the anti-solvent as completely as possible, via a solution feed line 18 into a second rectification 19 that is optionally equipped like the first one with an indirect sump heater. Whereas the stripped solution of the accompanying salts, that is largely depleted of NaSCN, is returned from the second rectification 19 via a mother liquor return line 20 into the washing circuit 4, the anti-solvent/water mixture obtained by the stripping in the second rectification 19 can be appropriately fed via an anti-solvent/water mixture line 22 into the first rectification 23. By this means the return of the anti-solvent into the drowning-out crystallization 12 can be implemented with the desired concentration from a single plant unit.

Via a NaSCN solution feed line 28 the concentrated NaSCN solution can be taken from the falling film evaporator 26 into the NaSCN crystallization 29 that can optionally be operated at a temperature range of 35 to 60°, for example, at 40° C. The mother liquor of the NaSCN crystallization 29 is returned via a mother liquor return line 30 into the drowning-out crystallization 12, so that also the fractions of ADA and NaVO3 still contained come back into the drowning-out crystallization 12. For an almost complete recovery and return of these valuable catalysts it is therefore of no significance that in the drowning-out crystallization 12 in each case only a fraction of these catalyst materials can be separated together with the other accompanying salts out of the mother liquor.

In order to obtain also with regard to colour a crystallized NaSCN 40 that is as pure white as possible, the crystallized mass drawn out of the NaSCN crystallizer 29 through a crystallized mass draw-off line 31 is fed to a counterstream washer 32, because usually the mother liquor is coloured. From the counterstream washer 32 the crystallized NaSCN is fed through a crystallized mass feed line 33 into a separating device that may be designed as centrifuge 34. The crystallized mass freed from adhering washing liquor in the centrifuge is then taken through a crystallized mass feeder 35 into a dryer 36 and dried there. The resulting NaSCN product 40 has a purity of typically better than 99.0%, such as 99.5% or 99.9%.

Saturated NaSCN solution is conveniently utilised as washing liquor for the counterstream washer 32, and for this purpose a fraction of the washed crystallized NaSCN is dissolved in water in a salt dissolver 39. In FIG. 5 the water feed to the salt dissolver 39 is designated with 41 and the crystallized mass feeder is designated with 38. Of course, instead of the depicted feed-in of a fraction of the centrifuged crystallized mass, a purge of a fraction out of the crystallized mass line 23 to the centrifuge 34 could also be provided.

It is advisable to feed the washing liquor separated in the centrifuge 34 through a drain line 36 also into the salt dissolver 39, from which a washing liquor feed line 42 feeds the washing liquor into the counterstream washer 32. The withdrawal of the washing liquor takes place through a washing liquor drain line 43 conveniently into the drowning-out crystallization 12, so that practically no NaSCN is lost.

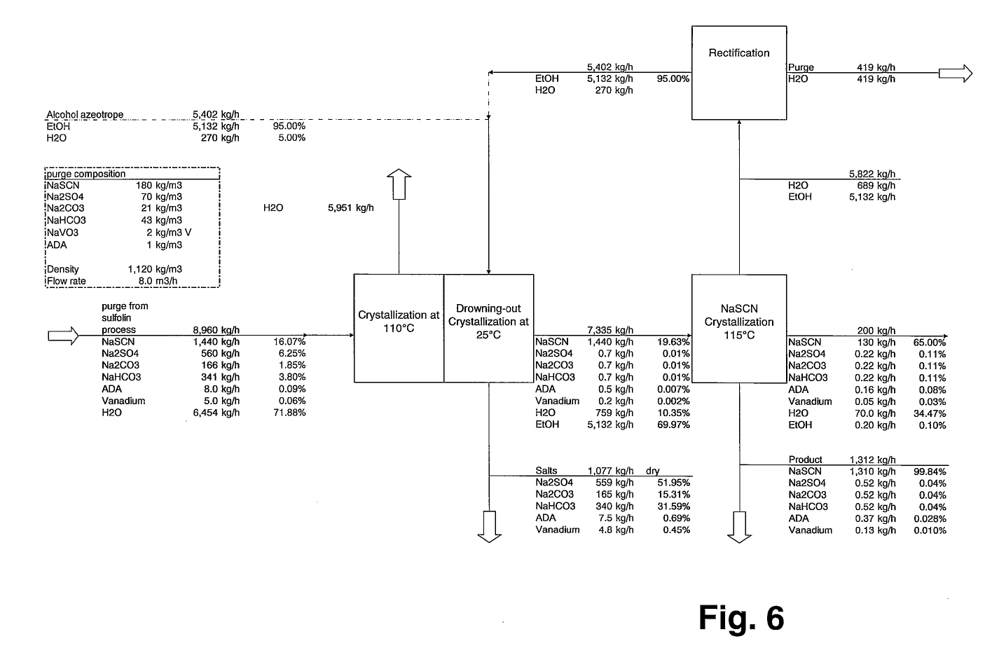

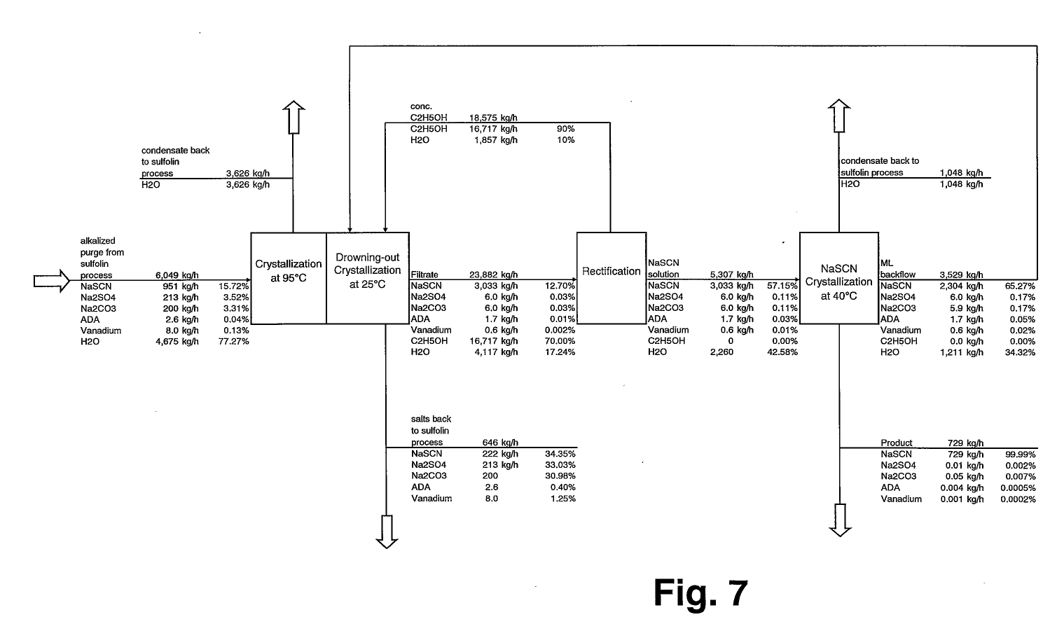

The FIGS. 6 and 7 show mass balances with regard to the main functional blocks of the process according to the invention, for two embodiment examples under different operating conditions. In FIG. 6 the anti-solvent is recovered from the vapours of the NaSCN crystallization whereas FIG. 7 is based on the process scheme of FIG. 5. In both cases EtOH was utilised as anti-solvent, and the purity of the obtained crystallized NaSCN was significantly better than 99.5%.

Changes and modifications to the specifically described embodiments may be carried out without departing from the principles of the present invention, which is intended to be limited only by the scope of the appended claims as interpreted according to the principles of patent law including the doctrine of equivalents.

1. A method for depleting sodium thiocyanate (NaSCN) in a circulating solution, containing other accompanying salts, of a washing process for removing sulphur, said method comprising:
adding an alcohol to a purged partial stream of the circulating solutions;
separating NaSCN from the solution, wherein the NaSCN removed out of the partial stream is obtained as marketable salt product;
at least partially returning the partial stream into the washing process after depletion of the NaSCN;
using an alcohol having at most 2 carbon atoms as an anti-solvent for a main fraction of the accompanying salts dissolved in water;
crystallizing a main fraction of the accompanying salts contained in the partial stream to separate the NaSCN; and
crystallizing out a mother liquor from the crystallization to obtain the NaSCN as highly concentrated salt.

2. The method according to claim 1, wherein using an alcohol comprises using ethanol.

3. The method according to claim 2, including purging the partial stream from a Glauber's salt crystallization linked to a circuit of the circulating solution.

4. The method according to claim 3, including subjecting the purged partial stream to a preliminary concentration by removing water before adding the anti-solvent.

5. The method according to claim 4, including carrying out the preliminary crystallization at a temperature in the range of 60 to 130° C.

6. The method according to claim 5, including carrying out the crystallization as cooling crystallization with indirect cooling at a temperature in the range of 10 to 60° C.

7. The method according to claim 6, including setting the concentration of the ethanol used as anti-solvent in the mother liquor of the crystallization at a mass percentage in the range of 40-90 percent.

8. The method according to claim 6, including subjecting the precipitate of the crystallization to a filtration.

9. The method according to claim 8, including returning the accompanying salts separated in the crystallization to the washing process.

10. The method according to claim 9, including removing the anti-solvent contained in the mother liquor drawn out of the crystallization to a first rectification.

11. The method according to claim 10, including producing an anti-solvent/water mixture in the first rectification, wherein the anti-solvent/water mixture has a concentration in excess of the concentration set in the crystallization, and returning the anti-solvent/water mixture into the crystallization.

12. The method according to claim 11, including concentrating the mother liquor of the crystallization up to close to the saturation point with respect to NaSCN, and subjecting the mother liquor to a vacuum cooling crystallization of the NaSCN.

13. The method according to claim 12, including completely dissolving a filter cake of the accompanying salts in an aqueous solvent comprising a condensate of water and a very small amount of anti-solvent obtained from the concentrating of the NaSCN solution, before return, for complete removal of the contained anti-solvent, wherein this solution is taken to a second rectification, wherein an anti-solvent/water mixture is recovered.

14. The method according to claim 13, including feeding the anti-solvent/water mixture from the second rectification into the first rectification.

15. The method according to claim 14, including subjecting the crystallized NaSCN to a counterstream washing process, and separating and drying the crystallized mass.

16. The method according to claim 15, including centrifuging the washed crystallized mass for separation.

17. The method according to claim 16, including dissolving a part of the crystallized NaSCN in water for preparing a washing liquor for the counterstream washing process, wherein a concentrated NaSCN solution is produced, wherein the separated part of the washing liquor is added to the concentrated NaSCN solution, wherein the washing liquor is fed into the crystallization after the counterstream washing process.

18. The method according to claim 17, including returning the mother liquor from the NaSCN crystallization into the crystallization.

19. A crystallized NaSCN with a purity of at least 99%, wherein the crystallized NaSCN is produced by a method for depleting NaSCN in a circulating solution, containing other accompanying salts, of a washing process for removing sulphur, said method comprising:
adding an alcohol to a purged partial stream of the circulating solution;
separating NaSCN from the solution, wherein the NaSCN removed out of the partial stream is obtained as marketable salt product;
at least partially returning the partial stream into the washing process after depletion of the NaSCN;
using an alcohol as an anti-solvent for a main fraction of the accompanying salts dissolved in water having at most 2 carbon atoms;
crystallizing a main fraction of the accompanying salts contained in the partial stream to separate the NaSCN and create a crystallization; and
crystallizing out a mother liquor from the crystallization to obtain the NaSCN as highly concentrated salt.

20. An apparatus for depleting sodium thiocyanate (NaSCN) in a circulating solution, comprising:
a separating device for NaSCN;
a cleaning system for removing sulphur out of a material containing sulphur, wherein the separating device is connected to a washing circuit of the cleaning system via a purge line, wherein a solvent is adapted to be fed into the cleaning system via a feed line, wherein a fraction of the solution depleted of NaSCN is adapted to be taken from the washing circulation via the purge line and returned into the washing circuit via a return line, wherein a fraction of the solution enriched with NaSCN is adapted to be taken via a line from the washing circuit into a device for producing crystallized NaSCN; and
wherein the separating device for NaSCN is designed as a crystallization device, wherein an alcohol is adapted to be introduced into the crystallization device via the feed line, the alcohol acting as anti-solvent for the main part of the salts present in the solution accompanying the NaSCN, wherein a mother liquor adapted to be fed from the crystallization device to a NaSCN crystallizer via a line, wherein the mother liquor, is substantially free of NaSCN and is adapted to be returned via a mother liquor return line to the crystallization device.

21. The apparatus according to claim 20, wherein the purge line emanates from a Glauber's salt crystallization included in the washing circuit.

22. The apparatus according to claim 21, wherein a preliminary crystallization is interposed upstream of the crystallization device.

23. The apparatus according to claim 22, wherein the crystallization device is designed as cooling crystallizer, with indirect cooling.

24. The apparatus according to claim 23, wherein the output line for the crystal suspension from the crystallization device leads to a filter.

25. The apparatus according to claim 24, wherein a line for the NaSCN solution leads from the filter into a first rectification for removing anti-solvent from the NaSCN solution.

26. The apparatus according to claim 25, including a dissolving device for completely dissolving filter residue from the filter in a condensate that is adapted to be fed through a line, and including a second rectification for complete removal of the anti-solvent from the solution, wherein the dissolving device and the second rectification are disposed downstream of the filter.

27. The apparatus according to claim 26, wherein a mixture of water and anti-solvent is adapted to be returned to the crystallization device from the first rectification via a line.

28. The apparatus according to the claim 26, wherein an anti-solvent/water mixture is adapted to be fed into the first rectification from the second rectification via an output line.

29. The apparatus according to claim 28, wherein a device for concentrating the NaSCN solution up to close to the saturation point is connected upstream to the NaSCN crystallizer.

30. The apparatus according to claim 29, wherein said device for concentrating the NaSCN solution comprises a falling film evaporator, wherein vapours from the falling film evaporator are discharged via a vapour output line fed at least partially into the condensate feed line of the dissolving device after condensation.

31. The apparatus according to claim 30, wherein the NaSCN crystallizer has a crystallized mass removal line leading to a cleaning device for the crystallized mass.

32. The apparatus according to claim 31, wherein the cleaning device comprises a counterstream washer, wherein a centrifuge for separating attached washing fluid is disposed downstream of the counterstream washer.

33. The apparatus according to claim 32, including a dryer for drying the crystallized NaSCN.

34. The apparatus according to claim 33, including a salt dissolver, wherein the washing fluid separated in the centrifuge and a part of the centrifuged crystallized NaSCN are fed into the salt dissolver through a crystallized mass feeder from the centrifuge and via a water feed line and via an output line,
wherein the saturated NaSCN solution produced in the salt dissolver is adapted to be fed as washing liquor through a washing liquor feeder into the counterstream washing apparatus.

35. The method according to claim 1, including purging the partial stream from a Glauber's salt crystallization linked to a circuit of the circulating solution.

36. The method according to claim 1, including subjecting the purged partial stream to a preliminary concentration by removing water before adding the anti-solvent.

37. The method according to claim 36, including carrying out the crystallization as cooling crystallization with indirect cooling at a temperature in the range of 10 to 60° C.

38. The method according to claim 36, including subjecting precipitate of the crystallization to a filtration.

39. The method according to claim 38, including returning the accompanying salts separated in the crystallization to the washing process.

40. The method according to claim 39, including removing the anti-solvent contained in the mother liquor drawn out of the crystallization to a first rectification.

41. The method according to claim 40, including producing an anti-solvent/water mixture in the first rectification, wherein the anti-solvent/water mixture has a concentration in excess of the concentration set in the crystallization, and further including returning the anti-solvent/water mixture into the crystallization.

42. The method according to claim 41, including concentrating the mother liquor of the crystallization up to close to the saturation point with respect to NaSCN, and subjecting the mother liquor to a vacuum cooling crystallization of the NaSCN.

43. The method according to claim 42, including completely dissolving a filter cake of the accompanying salts in an aqueous solvent comprising a condensate of water and a very small amount of anti-solvent obtained from the concentrating of the NaSCN solution, before return, for complete removal of the contained anti-solvent, wherein this solution is taken to a second rectification, wherein an anti-solvent/water mixture is recovered.

44. The method according to claim 43, including feeding the anti-solvent/water mixture from the second rectification into the first rectification.

45. The method according to claim 42, including subjecting the crystallized NaSCN to a counterstream washing process, and separating and drying the crystallized mass.

46. The method according to claim 45, including centrifuging the washed crystallized mass for separation.

47. The method according to claim 45, including dissolving a part of the crystallized NaSCN in water for preparing a washing liquor for the counterstream washing process, wherein a concentrated NaSCN solution is produced, wherein the separated part of the washing liquor is added to the concentrated NaSCN solution, wherein the washing liquor is fed into the crystallization after the counterstream washing process.

48. The method according to claim 40, including returning the mother liquor from the NaSCN crystallization into the crystallization.

49. The apparatus according to claim 20, wherein a preliminary crystallization is interposed upstream of the crystallization device.

50. The apparatus according to claim 49, wherein the crystallization device is designed as cooling crystallizer.

51. The apparatus according to claim 49, wherein the output line for the crystal suspension from the crystallization device leads to a filter.

52. The apparatus according to claim 51, wherein a line for the NaSCN solution leads from the filter into a first rectification for removing anti-solvent from the NaSCN solution.

53. The apparatus according to claim 52, including a dissolving device for completely dissolving filter residue from the filter in a condensate that is adapted to be fed through a line, and including a second rectification for complete removal of the anti-solvent from the solution, wherein the dissolving device and the second rectification are disposed downstream of the filter.

54. The apparatus according to claim 53, wherein a mixture of water and anti-solvent is adapted to be returned to the crystallization device from the first rectification via a line.

55. The apparatus according to claim 53, wherein an anti-solvent/water mixture is adapted to be fed into the first rectification from the second rectification via an output line.

56. The apparatus according to claim 49, wherein a device for concentrating the NaSCN solution up to close to the saturation point is connected upstream to the NaSCN crystallizer.

57. The apparatus according to claim 56, wherein said device for concentrating the NaSCN solution comprises a falling film evaporator, wherein vapours from the falling film evaporator are adapted to be discharged via a vapour output line and fed at least partially into the condensate feed line of the dissolving device after condensation.

58. The apparatus according to claim 57, wherein the NaSCN crystallizer has a crystallized mass removal line leading to a cleaning device for the crystallized mass.

59. The apparatus according to claim 58, wherein the cleaning device comprises a counterstream washer, wherein a centrifuge for separating attached washing fluid is disposed downstream of the counterstream washer.

60. The apparatus according to claim 59, including a dryer for drying the crystallized NaSCN.

61. The apparatus according to claim 60, including a salt dissolver, wherein the washing fluid separated in the centrifuge and a part of the centrifuged crystallized NaSCN is adapted to be fed into the salt dissolver through a crystallized mass feeder from the centrifuge and via a water feed line and via an output line, wherein the saturated NaSCN solution produced in the salt dissolver is adapted to be fed as washing liquor through a washing liquor feeder into the counterstream washing apparatus.
